(19) United States
(12) Patent Application Publication
(10) Pub. No.: US 2005/0211089 A1
(43) Pub. Date: Sep. 29, 2005

(54) Lubricant-cooled and wristpin lubricating piston

(76) Inventor: Douglas A. Doers, Franklin, WI (US)

Correspondence Address: MICHAEL BEST & FRIEDRICH, LLP, 100 E WISCONSIN AVENUE, MILWAUKEE, WI, 53202, US

(21) Appl. No.: 10/514,408

(22) PCT Filed: May 15, 2003
(86) PCT No.: PCT/US03/15560

§ 371 Date: Jun. 8, 2005

Related U.S. Application Data
(60) Provisional application No. 60/380,637, filed on May 15, 2002.

(51) Int. Cl. F16J 1/04

(52) U.S. Cl. 92/208

(57) ABSTRACT

A piston for an internal combustion engine including a skirt (32) and a crown (34). The skirt includes a top portion (48) and a cylindrically-shaped wall portion (50) extending from the top portion defining a skirt cavity (82). The top portion includes upper and lower surfaces. The lower surface is configured to define a bearing surface (72) for the wristpin (98). The crown is coupled to the skirt and includes a lower surface in facing relation to the upper surface. The lower surface of the crown and the upper surface define a lubrication cavity (46). The top portion includes at least one inlet hole (84) adapted to supply a lubricant from the skirt cavity to the lubrication cavity. The top portion includes at least one lubrication hole (90) adapted to supply the lubrication cavity to the bearing surface and the wristpin.

### FIELD OF THE INVENTION

The invention relates to pistons for internal combustion engines, and more particularly to lubricant cooled pistons for internal combustion engines.

### BACKGROUND OF THE INVENTION

Internal combustion engines generally include a piston that is mounted for reciprocation within a cylinder. The piston is coupled to a crankshaft by a connecting rod such that the reciprocation of the piston rotates the crankshaft. One end of the connecting rod is rotatably connected to a crankpin of the crankshaft and the other end of the connecting rod is connected to a wristpin of the piston. The wristpin can be rotatably connected to the piston and rigidly connected to the connecting rod such that the connecting rod and wristpin rotate relative to the piston as the piston reciprocates within the cylinder. Alternatively, the wristpin can be rigidly connected to the piston and rotatably connected to the connecting rod so that the connecting rod rotates relative to the wristpin and the piston as the piston reciprocates within the cylinder.

A number of different methods are used to lubricate the wristpin bearing surface. Typically, a hole drilled in the connecting rod transports lubricant supplied from the crankpin to the wristpin. When the connecting rod is rotatably connected to the wristpin, the hole supplies lubricant directly to the bearing surface between the connecting rod and the wristpin. When the connecting rod is rigidly connected to the wristpin, the hole directs lubricant to a passageway through the wristpin to supply the lubricant directly to the bearing surface between the piston and the wristpin.

It is also known to introduce lubricant into internal passageways within the piston to cool the piston during operation of the engine. Typically, a collimated jet of oil from an injection nozzle is directed into the cooling passageways to remove heat from the piston. In some configurations, the lubricant exits the cooling passageways from the underside of the piston and falls toward the wristpin to assist in lubricating the wristpin bearing surfaces. For example, the top of the connecting rod can include a hole that catches the exiting lubricant and that directs the lubricant to the bearing surface between the connecting rod and the wristpin. Historically, the wristpin has been spaced a distance from the lower surface of the piston and therefore the configurations disclosed in the prior art are incapable of directly lubricating the wristpin bearing surfaces with the lubricant exiting the cooling passages.

### SUMMARY OF THE INVENTION

The piston of the present invention uses lubricant for dual functions by diverting lubricant through the piston to cool the piston and to directly lubricate the bearing surfaces of the piston and a wristpin. The piston also reduces engine manufacturing costs by eliminating the need to drill holes through the connecting rod and wristpin while still providing direct lubrication to wristpin bearing surfaces.

One embodiment of the present invention is directed to a piston for an internal combustion engine including a skirt and a crown. The skirt includes a top portion and a cylindrically-shaped wall portion extending from the top portion defining a skirt cavity. The top portion includes upper and lower surfaces. The lower surface is configured to define a bearing surface for the wristpin. The crown is coupled to the skirt and includes a lower surface in facing relation to the upper surface. The lower surface of the crown and the upper surface of the skirt define a lubrication cavity. The top portion includes at least one inlet hole adapted to supply a lubricant from the skirt cavity to the lubrication cavity. The top portion includes at least one lubrication hole adapted to supply the lubricant from the lubrication cavity to the bearing surface and the wristpin.

Another embodiment of the present invention is directed to a piston including a skirt having a centrally-located threaded bore and a crown that is threadingly connected to the central bore to cover the top of the skirt. The skirt includes an annular shaped groove and a lubrication inlet hole in fluid flow communication between the bottom of the skirt and the annular groove. Six lubrication holes are in direct fluid communication between the annular groove and a bearing surface on the bottom of the skirt. Two bypass holes are in fluid communication between the annular groove and the central bore. A central lubrication hole is in fluid communication with the central bore and the bearing surface of the skirt.

During operation of a two-stroke engine according to another embodiment of the invention, a collimated jet of lubricant enters into the annular groove through the inlet hole to cool the piston. From the annular groove, a portion of the lubricant flows down through the six lubrication holes to lubricate the bearing surfaces of the skirt and the wristpin. Another portion of the lubricant flows from the annular groove through the two bypass holes and into the central bore. The remaining portion of the lubricant exits the annular groove through an exit hole. From the central bore, the lubricant flows through the central lubrication hole to lubricate the central portion of the bearing surfaces of the skirt and the wristpin.

Other features and advantages of the invention will become apparent to those skilled in'the art upon review of the following detailed description, claims, and drawings.

### BRIEF DESCRIPTION OF THE DRAWINGS

FIG. 1 is a partial cross-section view illustrating an engine having a piston assembly embodying the present invention.

FIG. 2 is a cross-section view taken along line 2-2 of FIG. 1.

FIG. 3 is a cross-section view taken along line 3-3 of FIG. 2.

FIG. 4 is an exploded view illustrating the piston shown in FIG. 1.

FIG. 5 is a top view of a skirt of the piston shown in FIG. 1.

FIG. 6 is a cross-section view taken along line 6-6 of FIG. 5.

FIG. 7 is a cross-section view taken along line 7-7 of FIG. 6.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items. The use of “consisting of” and variations thereof herein is meant to encompass only the items listed thereafter. The use of letters to identify elements of a method or process is simply for identification and is not meant to indicate that the elements should be performed in a particular order.

### DETAILED DESCRIPTION

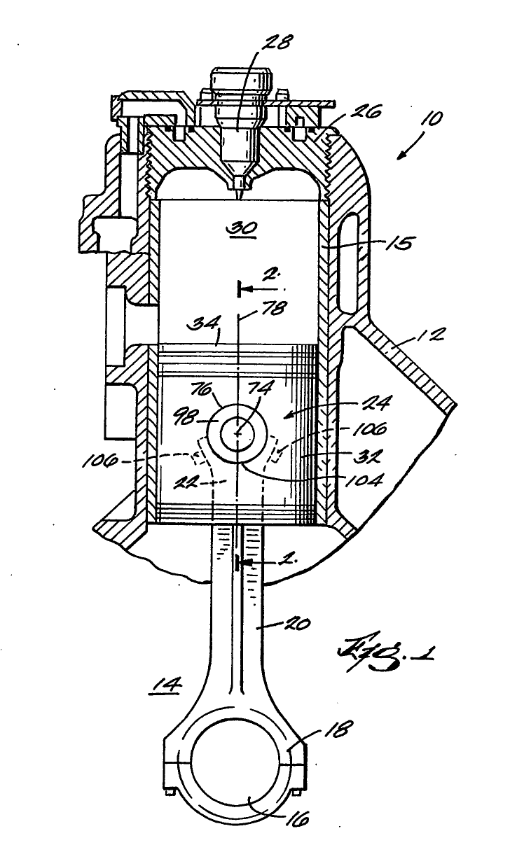

FIG. 1 illustrates a section view of an internal combustion engine 10 in which one embodiment of the present invention is employed. The engine 10 is a two-stroke, diesel aircraft engine, however, it should be understood that the present invention can also be used in other engines.

The engine 10 includes an engine block 12 at least partially defining a crankcase 14 and a cylinder 15. A crankshaft (not shown) is rotatably supported within the crankcase 14 and includes a crank pin 16. One end 18 of a connecting rod 20 is rotatably coupled to the crank pin 16, and the other end 22 of the connecting rod 20 is coupled to a piston 24 located within the cylinder 15 for reciprocation within the cylinder 15. A cylinder head 26 is threadingly engaged to the engine block 12 to cover the cylinder 15. A fuel injector 28 extends through the cylinder head 26 and injects fuel into a combustion chamber 30 defined by the cylinder head 26, the cylinder 15, and the piston 24.

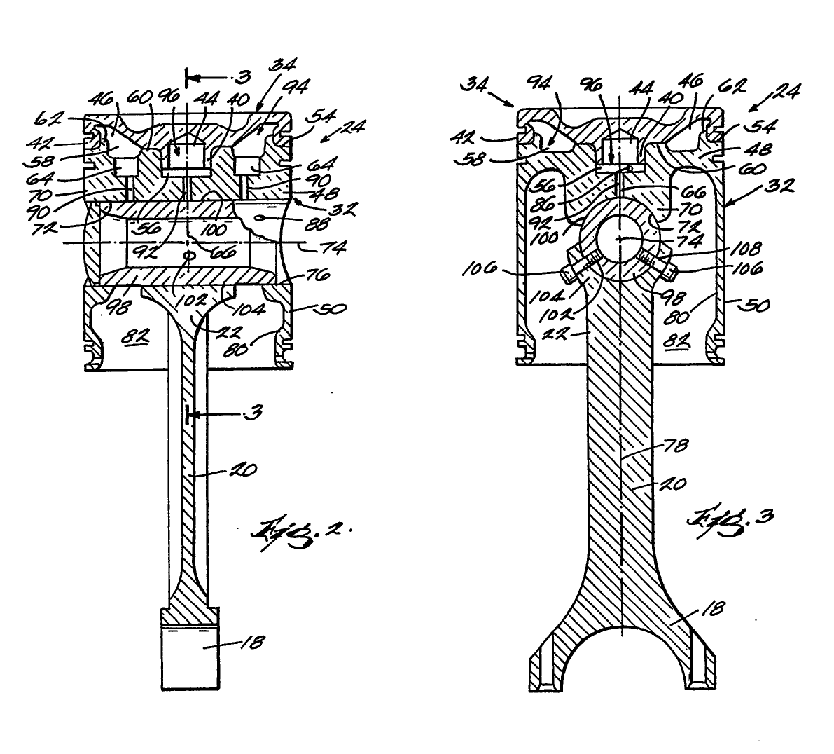

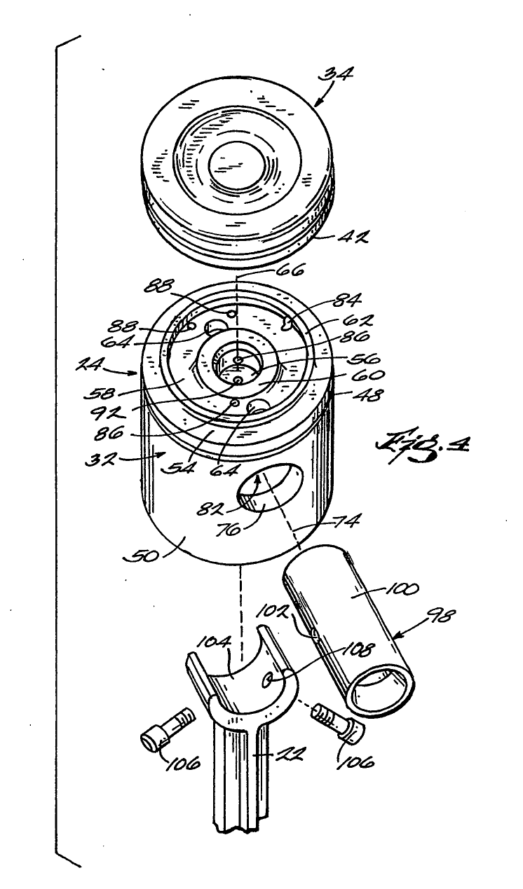

As best illustrated in FIG. 4, the piston 24 includes a skirt 32 and a crown 34 connected to the top of the skirt 32. The crown 34 is generally disc-shaped and includes a top surface configured to correctly direct the motion of the charge from the fuel injector 28 within the combustion chamber 30. With further reference to FIG. 2, the bottom surface of the crown 34 includes a centrally-extending threaded boss 40 and a downwardly-extending flange 42 about the periphery of the crown 34. The boss 40 includes a bore 44, and the bottom surface includes an annular groove 46 between the flange 42 and the boss 40.

Referring back to FIG. 4, the skirt 32 includes a generally disc-shaped top portion 48 and a cylindrical wall 50 extending downwardly from the periphery of the top portion 48. The upper surface of the top portion 48 includes a recessed edge 54 along the periphery, a centrally located threaded bore 56, and an annular groove 58 located between the central bore 56 and the recessed edge 54. A first annular wall 60 separates the annular groove 58 and the central bore 56, and a second annular wall 62 separates the annular groove 58 and the recessed edge 54. The upper surface includes a first recess 64 within the annular groove 58 on one side of a central axis 66 and a second recess 64 within the annular groove 58 on the opposite side of the central axis 66. As shown in FIG. 3, the bottom surface of the top portion 48 includes a raised portion 70 that includes an arcuate bearing surface 72. The bearing surface 72 extends along a longitudinal axis 74 between a first aperture 76 on one side of the wall 50 to another aperture 74 on the other side of the wall 50 (FIG. 2). As shown in FIG. 3, the longitudinal axis 74 defines a longitudinal plane 78, and the interior side 80 of the wall 50 and the lower surface of the skirt 32 define a skirt cavity 82.

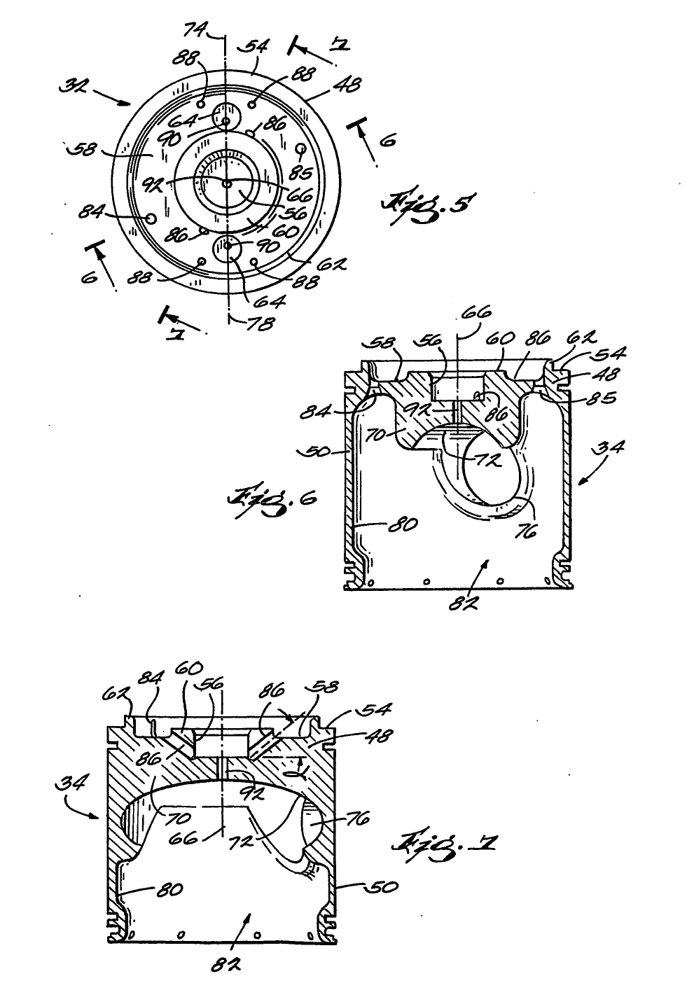

Referring to FIGS. 5 and 6, the top portion 48 includes an inlet hole 84 located on one side of the central axis 66 and an exit hole 85 located on the other side of the central axis 66 opposite to the inlet hole 84. The inlet hole 84 and the exit hole 85 extend between the annular groove 58 and the lower surface of the skirt 32 to fluidly communicate between the annular groove 58 and the skirt cavity 82. The inlet hole 84 and the exit hole 85 taper in the direction toward the annular groove 58.

Referring to FIGS. 5 and 7, the top portion 48 also includes a first passageway 86 on one side of the central axis 66 and a second passageway 86 located on the other side of the central axis 66 opposite to the first passageway 86. The passageways 86 fluidly communicate between the annular groove 58 and the central bore 56. More specifically, each passageway 86 includes a diameter of 0.187 inches and angles downward from a first end located adjacent to the bottom of the annular groove 58 to a second end located adjacent to the bottom of the central bore 56. As shown in FIG. 7, each passageway 86 defines an angle α, which preferably equals approximately 50 degrees.

As shown in FIGS. 2 and 5, the top portion includes outer lubricating holes 88 located near the annular wall 62. The outer lubricating holes 88 include a first pair on one side of the central axis 66 and a second pair on the other side of the central axis 66 opposite to the first pair. Each pair includes a first outer lubricating hole 88 offset a distance from the longitudinal plane 78 and a second outer lubricating hole 88 offset a similar distance on the opposite side of the longitudinal plane 78. Each outer lubricating hole 88 extends between the bottom surface of the annular groove 58 and the bearing surface 72 to fluidly communicate between the annular groove 58 and the skirt cavity 82.

As shown in FIGS. 2 and 5, the top portion 48 includes two intermediate lubricating holes 90 located within the recesses 64 along the longitudinal plane 78. The intermediate lubricating holes 90 extend between the bottom surface of the recess 64 to the bearing surface 72 to fluidly communicate between the annular groove 58 and the skirt cavity 82.

With reference to FIGS. 2, 3 and 5, the top portion 48 includes a central lubricating hole 92 located within the central bore 56 along the central axis 66 and the longitudinal plane 78. The central lubricating hole 92 extends between the bottom surface of the central bore 56 and the bearing surface 72 to fluidly communicate between the central bore 56 and the skirt cavity 82. Preferably, each of the lubricating holes 88, 90, 92 includes a diameter of approximately 0.125 inches.

As best shown in FIGS. 2 and 3, the crown 34 is connected to the skirt 32 by threading the boss 40 into the bore 56 such that the flange 42 is forced against the recessed edge 54 to form a seal. When the crown 34 and skirt 32 are connected, the annular grooves 46, 58 align to define an annular gallery 94, and the bore 44 combines with the central bore 56 to define a central cavity 96. The illustrated annular grooves 46, 58 are only one example of how the annular gallery 94 could be formed, and other annular galleries formed with annular grooves of varying depths are within the scope of the present invention. Additionally, the annular gallery 94 can be formed entirely by the annular groove of the skirt 32 or the crown 34. Similarly, the central cavity 96 can be formed entirely within the skirt 32, crown 34, or any combination of recesses on the skirt 32 and the crown 34. It should also be noted that the positions of the hollow boss 40 and the bore 56 could be reversed such that the hollow boss 40 is located on the skirt 32 and the bore 56 is located on the crown 34. Other methods of connecting the crown 34 and the skirt 32 to form the annular gallery 94 and the central cavity 96 are known to those skilled in the art and are within the scope of the present invention.

With additional reference to FIG. 4, a wristpin 98 is positioned through both apertures 76 and is rotatably supported by the wall 50. The wristpin 98 is a cylindrical tube having an exterior surface and an interior surface separated by a thickness. The upper portion of the exterior surface defines a bearing surface 100 that is in direct contact with the bearing surface 72. The lower portion of the wristpin 98 includes two holes 102.

The end 22 of the connecting rod 20 includes an arcuate portion 104 that contacts the lower portion of the wristpin 98. The arcuate portion 104 has an arcuate extent that extends about 180 degrees. A plurality of fasteners 106 extend through holes 108 in the arcuate portion 104 and into the holes 102 of the wristpin 98 to secure the wristpin 98 to the arcuate portion 104. The connecting rod 20 and the wristpin 98 could also be connected by extending the fasteners 106 into an annular wristpin insert (not shown) positioned within the wristpin 98 adjacent to the interior surface.

As best illustrated in FIG. 3, because the end 22 of the connecting rod 20 does not encircle the wristpin 98, the bearing surface 100 of the wristpin 98 directly contacts the bearing surface 72 of the skirt 32. This allows the upward forces of the wristpin 98 to be evenly distributed along the entire bearing surface 72 of the raised portion and the downward forces of the piston 24 to be evenly distributed along the entire bearing surface 100 of the wristpin 98. The increased area of the bearing surfaces 72, 100 minimizes uneven wear on the bearing surfaces 72, 100 during operation of the engine 10.

During operation of the engine 10, the piston 24 reciprocates in response to explosions within the combustion chamber 30 thereby rotating the crankshaft through the connecting rod 20. As the piston 24 moves toward the crankshaft, a collimated jet of lubricant is propelled from an injection nozzle (not shown) into the skirt cavity 82 where the lubricant is directed into the inlet hole 84. The lubricant passes through the inlet hole 84 to collect into the annular gallery 94. As the lubricant flows in the annular gallery 94, the lubricant absorbs the heat of the piston 24, thereby removing heat from the piston 24 to cool the piston 24. From the annular gallery 94, the lubricant flows out of the lubrication holes 88, 90, 92, flows into the passageways 86, or flows out of the exit hole 85. The lubrication that flows from the outer lubrication holes 88 flows directly to the bearing surface 72 offset from the longitudinal plane 78 to lubricate the bearing surfaces 72, 100 of the wristpin 98 and the skirt 32. The lubricant that flows from the intermediate lubrication holes 90 flows directly to the bearing surface 72 along the longitudinal plane 78 to lubricate the bearing surfaces 72, 100 of the wristpin 98 and the skirt 32. The recesses 64 within the annular groove 58 accumulate lubricant in order to concentrate flow of lubricant through the intermediate lubrication holes 90 and along the centerline of the bearing surfaces 72, 100, i.e., along the longitudinal plane 78.

The portion of the lubricant that flows through the passageways 86 collects in the central cavity 96. From the central cavity 96, the lubricant flows through the central lubrication hole 92 directly to the center of the bearing surface 72 along the central axis 66 to lubricate the bearing surfaces 72, 100 of the wristpin 98 and the skirt 32.

Lubricant flows directly from the annular gallery 94 of the piston 24 to the bearing surfaces 72, 100 of the wristpin 98 and the skirt 32 to thoroughly lubricate the bearing surfaces 72, 100. This is advantageous over known lubrication systems because known systems expel cooling lubricant from a piston to a wristpin that is spaced a distance from the lower surface of the piston. The distance between the lower surface of the piston and the wristpin makes it difficult to control the flow of the lubricant toward the wristpin bearing surface. In contrast, the lubrication system of the present invention precisely directs the lubricant exiting the piston annular gallery 94 between the bearing surfaces 72, 100 of the wristpin 98 and the skirt 32.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiments described herein are further intended to explain best modes known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

1. A piston for an internal combustion engine, the engine having a connecting rod coupled to a wristpin, the piston comprising:
a skirt having a top portion and a cylindrically-shaped wall portion extending from the top portion, the top and wall portions defining a skirt cavity, the top portion having an upper surface and an opposite lower surface within the skirt cavity, the lower surface configured to define a bearing surface for the wristpin; and
a crown coupled to the skirt, the crown having a lower surface in facing relation to the upper surface of the skirt, the lower surface of the crown and the upper surface of the skirt defining a lubrication cavity,
wherein the top portion of the skirt includes at least one inlet hole communicating between the skirt cavity and the lubrication cavity and adapted to supply a lubricant from the skirt cavity to the lubrication cavity, and wherein the top portion includes at least one lubrication hole communicating between the lubrication cavity and the skirt cavity and adapted to supply the lubricant from the lubrication cavity to the bearing surface and the wristpin.

2. The piston of claim 1, wherein the lubrication cavity is an annular cavity, and wherein the lower surface of the crown and the upper surface of the skirt define a central cavity centrally-located within the annular cavity, the central cavity communicating with the annular cavity through at least one bypass hole, and wherein the top portion includes at least one central lubrication hole communicating between the central cavity and the skirt cavity and adapted to lubricate a central portion of the wristpin.

3. The piston of claim 2, wherein the at least one bypass hole includes two bypass holes.

4. The piston of claim 2, wherein the central cavity includes internal threads, and wherein one of the crown or the top portion includes a threaded boss, and wherein the crown is coupled to the skirt by threadingly engaging the threaded boss with the internal threads.

5. The piston of claim 1, wherein the top portion includes at least one recess positioned within the lubrication cavity, and wherein at least one of the lubrication holes is located within the recess.

6. The piston of claim 1, wherein the top portion includes two recesses positioned within the lubrication cavity, and wherein at least one of the lubrication holes is located within each of the two recesses.

7. The piston of claim 1, wherein the at least one lubrication hole includes six lubrication holes.

8. The piston of claim 1, wherein at least one inlet hole includes two inlet holes.

9. A piston for an internal combustion engine, the engine having a connecting rod coupled to a wristpin, the piston comprising:
a skirt having a top portion and a cylindrically-shaped wall portion extending from the top portion, the top and wall portions defining a skirt cavity, the top portion having an upper surface; and
a crown coupled to the skirt, the crown having a lower surface in facing relation to the upper surface of the skirt, the lower surface of the crown and the upper surface of the skirt defining an annular cavity and a central cavity centrally-located within the annular cavity, the central cavity communicating with the annular cavity through at least one bypass hole,
wherein the top portion includes at least one inlet hole communicating between the skirt cavity and the annular cavity and adapted to supply a lubricant from the skirt cavity to the annular cavity, and wherein the top portion includes at least one lubrication hole communicating between the annular cavity and the skirt cavity and adapted to supply the lubricant from the annular cavity to the wristpin, and wherein the top portion includes at least one central lubrication hole communicating between the central cavity and the skirt cavity and adapted to lubricate a central portion of the wristpin.

10. The piston of claim 9, wherein the top portion includes a lower surface opposite to the upper surface of the skirt and within the skirt cavity, the lower surface configured to define a bearing surface for the wristpin.

11. The piston of claim 9, wherein the top portion includes at least one recess positioned within the annular cavity, and wherein at least one of the lubrication holes is located within the recess.

12. The piston of claim 9, wherein the top portion includes two recesses positioned within the annular cavity, and wherein at least one of the lubrication holes is located within each of the two recesses.

13. The piston of claim 9, wherein the at least one lubrication hole includes six lubrication holes.

14. The piston of claim 9, wherein the at least one bypass hole includes two bypass holes.

15. The piston of claim 9, wherein the central cavity includes internal threads, and wherein one of the crown or the top portion includes a threaded boss, and wherein the crown is coupled to the skirt by threadingly engaging the threaded boss with the internal threads.

16. The piston of claim 9, wherein at least one inlet hole includes two inlet holes.

17. A piston for an internal combustion engine, the engine having a connecting rod coupled to a wristpin, the piston comprising:
a skirt defining a skirt cavity including a bearing surface for the wristpin;
an uppermost surface partially defining a combustion chamber;
a lubrication cavity between the uppermost surface and the bearing surface;
at least one inlet hole communicating between the skirt cavity and the lubrication cavity and adapted to supply a lubricant from the skirt cavity to the lubrication cavity; and
at least one lubrication hole communicating between the lubrication cavity and the skirt cavity and adapted to supply the lubricant from the lubrication cavity to the bearing surface and the wristpin.
